(19) United States
(12) Patent Application Publication
(10) Pub. No.: US 2024/0202707 A1
(43) Pub. Date: Jun. 20, 2024

(54) TRUST WALLET

(71) Applicants: Sony Group Corporation, Tokyo (JP); Sony Corporation of America, New York, NY (US)

(72) Inventor: Thomas Sachson, Malibu, CA (US)

(21) Appl. No.: 18/545,480

(22) Filed: Dec. 19, 2023

Related U.S. Application Data
(60) Provisional application No. 63/476,288, filed on Dec. 20, 2022.

(51) Int. Cl. G06Q 20/36; G06Q 20/38

(52) U.S. Cl. CPC G06Q 20/3674; G06Q 20/389

(57) ABSTRACT

Digital authentication of a product using a digital wallet of a user, including: generating a blockchain for the product; receiving and matching a serial number for the product to the digital wallet of the user; and adding the generated blockchain to the digital wallet.

### CROSS-REFERENCE TO RELATED APPLICATIONS

This application claims the benefit of priority under 35 U.S.C. § 119 (e) of co-pending U.S. Provisional Patent Application No. 63/476,288, filed Dec. 20, 2022, entitled “Trust Wallet”. The disclosure of the above-referenced application is incorporated herein by reference.

### BACKGROUND

### Field

The present disclosure relates to digital wallets, and more specifically, to connecting the digital wallets to a decentralized storage system (e.g., a blockchain) and to storing and authenticating asset information (e.g., currency, non-fungible tokens (NFTs), or other electronic and online assets).

### Background

As digital technology and artificial intelligence advance, it is becoming increasingly difficult to distinguish between authentic and manipulated digital item(s). Moreover, unauthorized use of digital items and the proliferation of fake items have created a need for a robust and reliable method to authenticate digital items that represent real events, with such events including meta data associated with date, time, place, environmental factors present, people present, and analogous circumstantial data points that may be relevant to establishing the truth, realness, and content of a digital item.

Existing methods of digital authentication rely on watermarking, digital signatures, or meta data, but these approaches may be vulnerable to tampering and do not provide a secure end-to-end chain of custody. Thus, there is a need for a digital item authentication system that provides an end-to-end chain of custody service for digital items by connecting a digital wallet to a decentralized storage system (e.g., a blockchain) and by storing and authenticating asset information (e.g., currency, non-fungible tokens (NPTs), or other electronic and online assets).

### SUMMARY

The present disclosure implements techniques for digital item authentication that provides an end-to-end chain of custody service for digital items by connecting a digital wallet to a decentralized storage system and by storing and authenticating asset information.

In one implementation, a method of digital authentication of a product using a digital wallet of a user is disclosed. The method includes: generating a blockchain for the product; receiving and matching a serial number for the product to the digital wallet of the user; and adding the generated blockchain to the digital wallet.

In another implementation, a system for digital authentication of a product using a digital wallet of a user is disclosed. The system includes: a blockchain generator to generate a blockchain for the product; and a processor to receive a serial number for the product entered by the user during product registration, the processor to match the serial number to the digital wallet of the user, the processor to add the generated block chain to the digital wallet of the user.

In another implementation, a non-transitory computer-readable storage medium storing a computer program to digitally authenticate a product using a digital wallet of a user is disclosed. The computer program includes executable instructions that cause a computer to: generate a blockchain for the product; receive and match a serial number for the product to the digital wallet of the user; and add the generated blockchain to the digital wallet.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow chart of a digital authentication method using a digital wallet in accordance with one implementation of the present disclosure;

FIG. 2 is a flow diagram of a method of a product using a digital wallet in accordance with one implementation of the present disclosure;

FIG. 3 is a block diagram of a system for digital authentication of a product using a digital wallet in accordance with one implementation of the present disclosure;

FIG. 4A is a representation of a computer system and a user in accordance with an implementation of the present disclosure; and

FIG. 4B is a functional block diagram illustrating the computer system hosting the digital authentication application in accordance with an implementation of the present disclosure.

### DETAILED DESCRIPTION

As described above, existing methods of digital authentication may be vulnerable to tampering and do not provide a secure end-to-end chain of custody.

To address the above-described issues with the digital authentication, implementations of the present disclosure provide for a digital item authentication system that provides an end-to-end chain of custody service for digital items by connecting a digital wallet to a decentralized storage system (e.g., a blockchain) and by storing and authenticating asset information (e.g., currency, non-fungible tokens (NFTs), or other electronic and online assets).

In one implementation, the digital items include at least one of photos, videos, audio clips, emails, texts, social posts, screen shots, and personal data/preferences. In another implementation, the digital wallet supports additional assets, such as those related to currencies, NFTs, and content, and the digital items include at least one of reward points, coins or tokens for services, crypto currencies, game digital merchandises, skins or cosmetic items for content use, and entitlements in services.

In one implementation, the digital wallet leverages product registration to authenticate asset information. In this implementation, the product (and/or user) registration is added to the wallet. The registration process for the user and product creates a new digital wallet if needed and adds the registration to the wallet. This creates new wallets with accurate information. Thus, a product registration authentication wallet is for users wishing to confirm that their purchased products are not counterfeit (authenticity) and that the user may pass good title to such product to third parties if they resell them. This may help fight the proliferation of counterfeit goods and blunt the influence of global organized crime involved in the trade of counterfeit goods.

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

Features provided in various implementations for the digital wallet may include a trust wallet to validate consumer products on the blockchain. The consumer products may include, but are not limited to, one or more of the following items: (a) consumer electronics (e.g., cameras, televisions, audio devices, robots, drones, mobile phones, tablets, printers, and computers); (b) gaming devices (e.g., consoles and peripherals); (c) home entertainment products (e.g., DVDs); (d) luxury goods (e.g., leather goods, clothing, shoes, luggage, handbags, eyewear, and jewelry); (e) vehicle products (e.g., automobiles, motorbikes, and accessories); and (f) digital assets (e.g., audio, video, photographic, and computer code) created by retail consumers (i.e., user-generated content).

The purpose of such a trust wallet service include: (a) validation to customers that their purchased goods are authentic and owned by the purchaser; (b) comfort to customers that any resale of such products to third parties will be accompanied by proof of authenticity and certified transfer of ownership; and (c) a strong disincentive to those bad actors that would engage in counterfeit and/or theft activities.

One implementation of a trust wallet is focused on registration from a single source. This wallet includes: (a) simple owner ID paired to a device blockchain registration; (b) low-cost Layer 1 blockchain recordation; (c) easy to use custodial or non-custodial wallet UX (native app and web-app); (d) no crypto fee/no gas dynamic, or low crypto fee/low gas dynamic; (e) outsourced team to keep development costs down; and (f) physical asset authentication, or digital asset authentication.

In another implementation, the trust wallet also includes registration for multiple sources. This wallet leverages common interests and “communities of interest” to increase use and adoption. In another implementation, product registrations are added to the wallet as NFT assets. In one example, the initial product registration for each product is added as a respective NFT. In another implementation, the trust wallet supports multiple asset classes, in addition to the product registration. This wallet enables customers to register and manage ownership title on the blockchain to their user-generated content (“UGC”) non-physical assets, as well as their personal user and preference data. In one implementation, a wallet system progressively adopts various additional wallet implementations as the wallet user base grows.

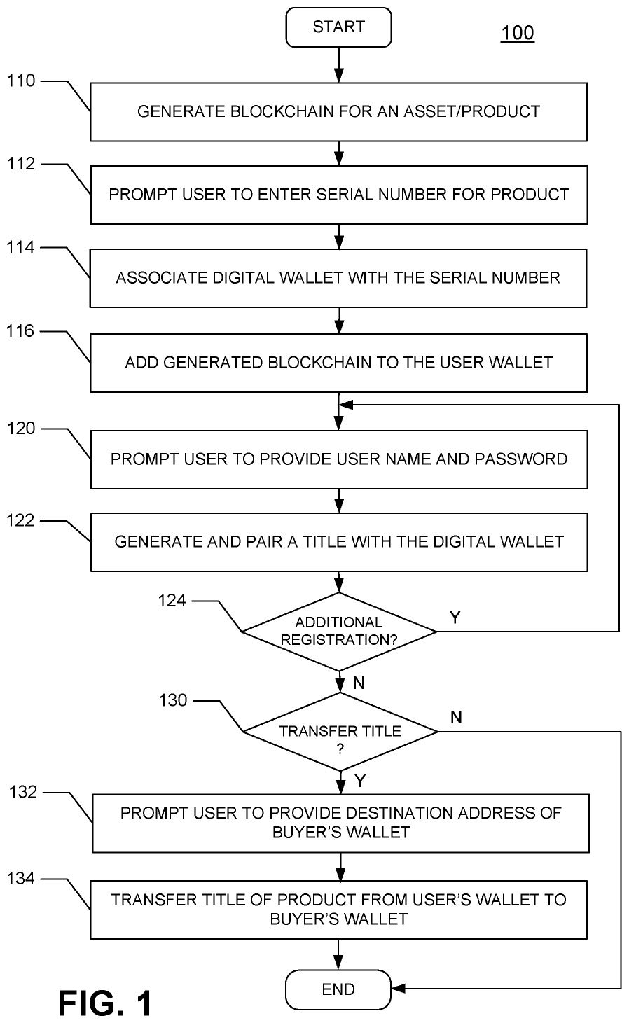

FIG. 1 is a flow chart of a digital authentication method 100 using a digital wallet in accordance with one implementation of the present disclosure. In one implementation, the digital wallet is a trust wallet. In another implementation, the trust wallet is a Web3 wallet.

In the illustrated implementation of FIG. 1, the digital wallet leverages product registration to authenticate asset/product information. In one implementation, when a product is built and a serial number is assigned to the product, a blockchain is generated, at block 110, for the product. In one implementation, the product includes one of: a consumer electronic device including a camera, television, audio device, robot, drone, mobile phone, tablet, printer, and computer; a gaming device including a console and peripheral; a home entertainment product including a DVD; luxury goods including leather goods, clothing, shoes, luggage, handbags, eyewear, and jewelry; vehicle products including automobiles, motorbikes, and accessories; and a digital asset including audio, video, photographic, and computer code created by retail consumers (i.e., user-generated content).

A user is prompted to enter a serial number for the product, at block 112, during the product registration. Once the serial number is matched to the user, at block 112, a digital wallet is associated with the serial number, at block 114, and the generated block chain is added to the wallet of the user, at block 116. In this implementation, the user and product registration are added to the wallet. The registration process for the user and the product creates a new digital wallet if needed and adds the registration to the wallet. This creates new wallets with accurate information. Thus, a product registration authentication wallet is for users wishing to confirm that their purchased products are not counterfeit (authenticity) and that the user may pass good titles to such products to third parties.

In one implementation, the digital wallet is a trust wallet that validates enterprise products on the blockchain, wherein the enterprise products include: electronic components used in consumer electronics; electronic components used in vehicle manufacture including automobiles, motorbikes, and accessories; raw materials used in the creation of components including processors, memory, power sources, substrates, and coatings; and digital assets.

In the illustrated implementation of FIG. 1, the user is prompted to provide user name and password, at box 120, to manage the digital wallet. A title to the serial number associated with the product is then generated and paired with the digital wallet, at box 122. Once the product is registered and the digital wallet is paired with the user, any subsequent registration (block 124) of another product (to the same digital wallet) by the same user may be done using a rapid registration (e.g., one-click registration) by repeating the steps of blocks 120 and 122.

In one implementation, the digital wallet also provides a transfer function for moving the title of the product from the user to a buyer. Thus, when a request from the user is received, at block 130, that the user wishes to transfer the title to the product to a buyer, the user is prompted to provide a destination address of the wallet of the buyer, at block 132. The title of the product (e.g., the blockchain associated with the product) is then transferred, at block 134, from the digital wallet of the user to the wallet of the buyer.

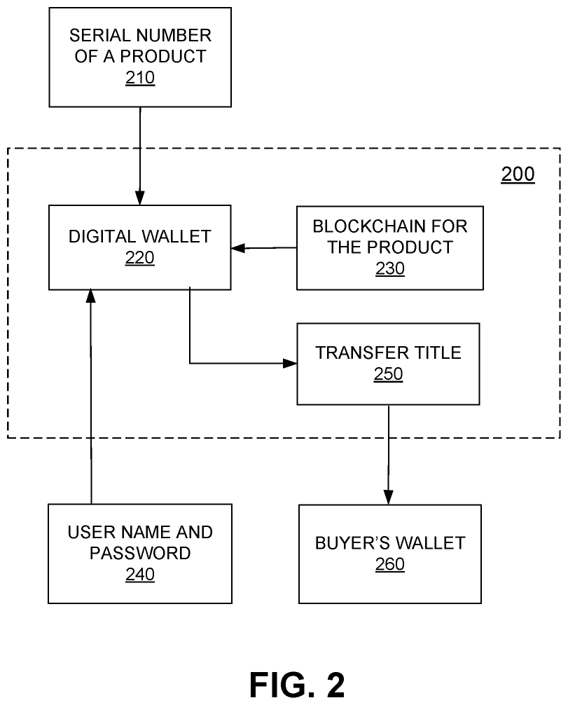

FIG. 2 is a flow diagram of a method 200 of a product using a digital wallet 220 in accordance with one implementation of the present disclosure. Initially, a serial number for the product 210 is entered during the product registration by a user. Once the serial number 210 is matched to the user, the digital wallet 220 is associated with the serial number 210, and a block chain 230 for the product is generated and added to the digital wallet 220 of the user. In this implementation, the user and product registration are added to the wallet 220. The registration process for the user and the product creates a new digital wallet if needed and adds the registration to the wallet. This creates new wallets with accurate information. Thus, a product registration authentication wallet is for users wishing to confirm that their purchased products are not counterfeit (authenticity) and that the user may pass good titles to such products to third parties.

In the illustrated implementation of FIG. 2, the user enters user name and password 240 to manage the digital wallet 220. A title (e.g., a block chain 230) to the serial number 210 associated with the product is then generated and paired with the digital wallet 220. Once the product is registered and the digital wallet 220 is paired with the user, any subsequent registration of another product (to the same digital wallet 220) by the same user may be done using a rapid registration (e.g., one-click registration).

In one implementation, the digital wallet 220 also provides a transfer function 250 for moving the title of the product from the user to a buyer. Thus, when the user sends a request to transfer the title 230 to the product to a buyer, and provides a destination address of the wallet of the buyer to the transfer function 250, the title of the product is then transferred from the digital wallet 220 of the user to the wallet of the buyer 260.

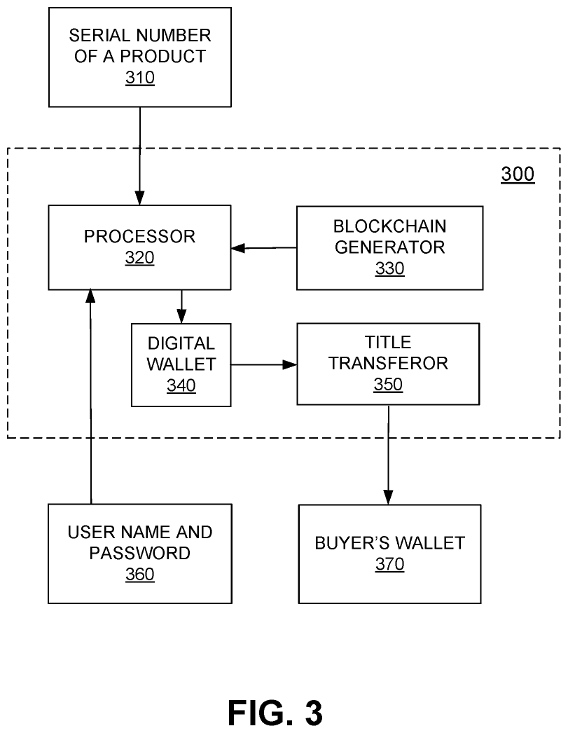

FIG. 3 is a block diagram of a system 300 for digital authentication of a product using a digital wallet in accordance with one implementation of the present disclosure. In the illustrated implementation of FIG. 3, the system 300 includes a processor 320, a blockchain generator 330, a digital wallet 340, and a title transferor 350. In one implementation, the system 300 leverages product registration to authenticate asset/product information.

In one implementation, when the product is built, a serial number 310 is assigned to the product. Further, a blockchain generator 330 generates a blockchain for the product. Initially, the processor 320 receives the serial number 310 for the product entered by a user during the product registration. The processor 320 also matches the serial number to the user and a digital wallet of the user is associated with the serial number. The processor 320 further adds the generated block chain to the wallet 340 of the user. In this implementation, the user and product registration are added to the wallet. The registration process for the user and the product creates a new digital wallet if needed and adds the registration to the wallet. This creates new wallets with accurate information. Thus, a product registration authentication wallet is for users wishing to confirm that their purchased products are not counterfeit (authenticity) and that the user may pass good titles to such products to third parties. In the illustrated implementation of FIG. 3, the processor 320 also receives the user name and password 360 entered by the user to manage the digital wallet 340.

In one implementation, when the user requests the system 300 to transfer the title to a buyer, the processor 320 directs the title transferor 350 to generate a title to the serial number associated with the product and stores it in the digital wallet 340. The title transferor 350 pairs the title with the digital wallet 340. Thus, when the user wishes to transfer the title to the product to the buyer, the title transferor 350 receives a destination address of the wallet of the buyer 370 and transfers the title of the product (e.g., the blockchain associated with the product) from the digital wallet 340 of the user to the wallet of the buyer 370.

In one implementation, the blocks 320, 330, 340, 350, and 370 are configured entirely with hardware including one or more digital signal processors (DSPs), general purpose microprocessors, application specific integrated circuits (ASICs), field programmable logic arrays (FPGAs), or other equivalent integrated or discrete logic circuitry. One implementation includes one or more programmable processors and corresponding computer system components to store and execute computer instructions, such as to provide the operation of a wallet infrastructure at the user level and provider level (provider of products, assets, content, etc.).

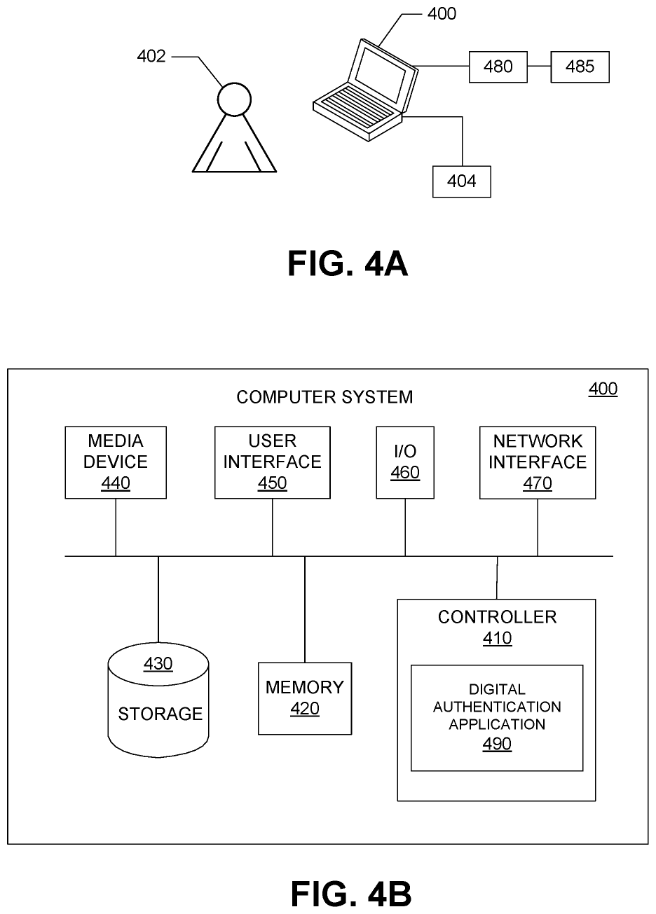

FIG. 4A is a representation of a computer system 400 and a user 402 in accordance with an implementation of the present disclosure. The user 402 uses the computer system 400 to implement an authentication application 490 for authenticating digital assets using a digital wallet with respect to the process 100 of FIG. 1 and the system 300 of FIG. 3.

The computer system 400 stores and executes the digital authentication application 490 of FIG. 4B. In addition, the computer system 400 may be in communication with a software program 404. Software program 404 may include the software code for the digital authentication application 490. Software program 404 may be loaded on an external medium such as a CD, DVD, or a storage drive, as will be explained further below.

Furthermore, the computer system 400 may be connected to a network 480. The network 480 may be connected in various different architectures, for example, client-server architecture, a Peer-to-Peer network architecture, or other type of architectures. For example, network 480 may be in communication with a server 485 that coordinates engines and data used within the digital authentication application 490. Also, the network may be different types of networks. For example, the network 480 may be the Internet, a Local Area Network or any variations of Local Area Network, a Wide Area Network, a Metropolitan Area Network, an Intranet or Extranet, or a wireless network.

FIG. 4B is a functional block diagram illustrating the computer system 400 hosting the digital authentication application 490 in accordance with an implementation of the present disclosure. A controller 410 is a programmable processor and controls the operation of the computer system 400 and its components. The controller 410 loads instructions (e.g., in the form of a computer program) from the memory 420 or an embedded controller memory (not shown) and executes these instructions to control the system, such as to provide the data processing. In its execution, the controller 410 provides the digital authentication application 490 with a software system. Alternatively, this service may be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data either temporarily or for long periods of time for use by the other components of the computer system 400. For example, storage 430 stores data used by the digital authentication application 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. In another implementation, the user interface 450 also includes a headset worn by the user and used to collect eye movements as user inputs. The controller 410 uses input from the user 402 to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system may be used (e.g., different bus or storage configurations or a multi-processor configuration).

In one particular implementation, a method of digital authentication of a product using a digital wallet of a user is disclosed. The method includes: generating a blockchain for the product; receiving and matching a serial number for the product to the digital wallet of the user; and adding the generated blockchain to the digital wallet.

In one implementation, the method further includes prompting the user to provide user name and password to manage the digital wallet. In one implementation, receiving and matching the serial number to the digital wallet is performed during an initial registration of the product. In one implementation, the method further includes enabling a rapid registration of additional products for registrations subsequent to the initial registration of the product by generating and pairing titles to serial numbers associated with the additional products with the digital wallet. In one implementation, the method further includes generating and pairing a title to the serial number associated with the product with the digital wallet. In one implementation, the method further includes receiving a destination address of a buyer wallet; and transferring the title from the digital wallet of the user to the buyer wallet. In one implementation, the digital wallet is a trust wallet. In one implementation, the trust wallet is a Web3 wallet. In one implementation, the product includes a consumer electronic device including one of a camera, television, audio device, robot, drone, mobile phone, tablet, printer, or computer. In one implementation, the product includes a gaming device including one of a console or peripheral. In one implementation, the product includes a home entertainment product including a DVD. In one implementation, the product includes luxury goods including one of leather goods, clothing, shoes, luggage, handbags, eyewear, or jewelry. In one implementation, the product includes vehicle products including one of automobiles, motorbikes, or accessories. In one implementation, the product includes a digital asset including one of audio, video, photographic, and computer code created by retail consumers.

In another particular implementation, a system for digital authentication of a product using a digital wallet of a user is disclosed. The system includes: a blockchain generator to generate a blockchain for the product; and a processor to receive a serial number for the product entered by the user during product registration, the processor to match the serial number to the digital wallet of the user, the processor to add the generated block chain to the digital wallet of the user.

In one implementation, the system further includes the processor to add user and product registration to the digital wallet of the user. In one implementation, the system further includes a title transferor to generate and store a title to the serial number associated with the product in the digital wallet of the user. In one implementation, the system further includes the title transferor to receive a destination address of a buyer wallet and transfer the title of the product from the digital wallet of the user to the buyer wallet.

In another particular implementation, a non-transitory computer-readable storage medium storing a computer program to digitally authenticate a product using a digital wallet of a user is disclosed. The computer program includes executable instructions that cause a computer to: generate a blockchain for the product; receive and match a serial number for the product to the digital wallet of the user; and add the generated blockchain to the digital wallet.

In one implementation, the executable instructions that cause the computer to receive and match the serial number to the digital wallet is performed during an initial registration of the product.

The description herein of the disclosed implementations is provided to enable any person skilled in the art to make or use the present disclosure. Numerous modifications to these implementations would be readily apparent to those skilled in the art, and the principles defined herein can be applied to other implementations without departing from the spirit or scope of the present disclosure. Thus, the present disclosure is not intended to be limited to the implementations shown herein but is to be accorded the widest scope consistent with the principal and novel features disclosed herein. Accordingly, additional variations and implementations are also possible.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method of digital authentication of a product using a digital wallet of a user, the method comprising:
generating a blockchain for the product;
receiving and matching a serial number for the product to the digital wallet of the user; and
adding the generated blockchain to the digital wallet.

2. The method of claim 1, further comprising
prompting the user to provide user name and password to manage the digital wallet.

3. The method of claim 1, wherein receiving and matching the serial number to the digital wallet is performed during an initial registration of the product.

4. The method of claim 3, further comprising
enabling a rapid registration of additional products for registrations subsequent to the initial registration of the product by generating and pairing titles to serial numbers associated with the additional products with the digital wallet.

5. The method of claim 1, further comprising
generating and pairing a title to the serial number associated with the product with the digital wallet.

6. The method of claim 5, further comprising
receiving a destination address of a buyer wallet; and
transferring the title from the digital wallet of the user to the buyer wallet.

7. The method of claim 1, wherein the digital wallet is a trust wallet.

8. The method of claim 7, wherein the trust wallet is a Web3 wallet.

9. The method of claim 1, wherein the product includes a consumer electronic device including one of a camera, television, audio device, robot, drone, mobile phone, tablet, printer, or computer.

10. The method of claim 1, wherein the product includes a gaming device including one of a console or peripheral.

11. The method of claim 1, wherein the product includes a home entertainment product including a DVD.

12. The method of claim 1, wherein the product includes luxury goods including one of leather goods, clothing, shoes, luggage, handbags, eyewear, or jewelry.

13. The method of claim 1, wherein the product includes vehicle products including one of automobiles, motorbikes, or accessories.

14. The method of claim 1, wherein the product includes a digital asset including one of audio, video, photographic, and computer code created by retail consumers.

15. A system for digital authentication of a product using a digital wallet of a user, the system comprising:
a blockchain generator to generate a blockchain for the product; and
a processor to receive a serial number for the product entered by the user during product registration,
the processor to match the serial number to the digital wallet of the user,
the processor to add the generated block chain to the digital wallet of the user.

16. The system of claim 15, further comprising
the processor to add user and product registration to the digital wallet of the user.

17. The system of claim 15, further comprising
a title transferor to generate and store a title to the serial number associated with the product in the digital wallet of the user.

18. The system of claim 17, further comprising
the title transferor to receive a destination address of a buyer wallet and transfer the title of the product from the digital wallet of the user to the buyer wallet.

19. A non-transitory computer-readable storage medium storing a computer program to digitally authenticate a product using a digital wallet of a user, the computer program comprising executable instructions that cause a computer to:
generate a blockchain for the product;
receive and match a serial number for the product to the digital wallet of the user; and
add the generated blockchain to the digital wallet.

20. The non-transitory computer-readable storage medium of claim 1, wherein the executable instructions that cause the computer to receive and match the serial number to the digital wallet is performed during an initial registration of the product.
